(19) United States
(12) Patent Application Publication
(10) Pub. No.: US 2005/0007991 A1
(43) Pub. Date: Jan. 13, 2005

(54) Bandwidth allocation method and apparatus for fixed wireless networks

(76) Inventors: Dat Ton, San Jose, CA (US); Kamlesh Rath, San Ramon, CA (US)

Correspondence Address: GLENN PATENT GROUP, 3475 EDISON WAY, SUITE L, MENLO PARK, CA, 94025, US

(21) Appl. No.: 10/619,369

(22) Filed: Jul. 10, 2003

(51) Int. Cl. H04J 3/24

(52) U.S. Cl. 370/349

(57) ABSTRACT

A simple, fair, good-performance bandwidth allocation algorithm for wireless networks is presented. Using a matrix of interlink interference and a list of links' bandwidth requests, the algorithm can schedule link activities to obtain non-collision transmissions. All bandwidth requests are served fairly and near-optimally based on the heuristic algorithm. Bandwidth granted for each link is prorated based on its requested bandwidth, total requested bandwidth in the network, and network capacity. The algorithm can be used for centralized bandwidth allocation and works with any network topology, including mesh networks.

### BACKGROUND OF THE INVENTION

1. Technical Field

The invention relates to bandwidth allocation in wireless networks. More particularly, the invention relates to optimizing bandwidth allocation for a fixed wireless network using a simple centralized algorithm to create a fair and efficient, high-performance bandwidth allocation schedule.

2. Description of the Prior Art

The allocation of bandwidth on demand in wireless access networks is important to provide high call-carrying capacity yet prevent degradation in the quality of a link due to interference arising from a number of simultaneous transmissions. The problem of bandwidth allocation is one of allocation of radio resources for the duration of a transmission in both the uplink and downlink directions. The capacity of any cell is reached when the current resource utilization prevents the admission of additional calls, even at the lowest rate.

Wireless networks are expected to support real-time interactive multimedia traffic and must be able, therefore, to provide their users with Quality-of-Service (QoS) guarantees. Although the QoS provisioning problem arises in wireline networks as well, mobility of hosts and scarcity of bandwidth makes QoS provisioning a challenging task in wireless networks. One problem with optimizing bandwidth allocation in a fixed wireless network concerns that fact that, given the constraints of the interference matrix and a list of bandwidth requests, it is difficult to find a schedule that makes optimal use of total network capacity and fairly satisfies bandwidth requests.

An equivalent problem is that of finding an optimal schedule that satisfies all requests using the least amount of network resources where, if the average activity concurrency is defined as the average number of concurrent active links of a schedule, then the optimal schedule is the one having the highest average activity concurrency.

It would be advantageous to provide a method and apparatus for optimizing bandwidth allocation for a fixed wireless network using a simple centralized algorithm to create a fair and efficient, high-performance bandwidth allocation schedule.

### SUMMARY OF THE INVENTION

The invention provides a method and apparatus for optimizing bandwidth allocation for a fixed wireless network using a simple centralized algorithm to create a fair and efficient, high-performance bandwidth allocation schedule. A simple, fair, good-performance bandwidth allocation algorithm for wireless networks is presented. Using a matrix of interlink interference and a list of links' bandwidth requests, the algorithm can schedule link activities to obtain non-collision transmissions. All bandwidth requests are served fairly and near-optimally based on the heuristic algorithm. Bandwidth granted for each link is prorated based on its requested bandwidth, total requested bandwidth in the network, and network capacity. The algorithm can be used for centralized bandwidth allocation and works with any network topology, including mesh networks.

### BRIEF DESCRIPTION OF THE DRAWINGS

FIG. 1 is a tree diagram that shows a network having eleven nodes and twenty directional links;

FIG. 2 is a block schematic diagram showing a system for bandwidth allocation in a fixed wireless network according to the invention; and

FIG. 3 is a flow diagram showing an algorithm for bandwidth allocation in a fixed wireless network according to the invention.

### DETAILED DESCRIPTION OF THE INVENTION

The invention provides a method and apparatus for optimizing bandwidth allocation for a fixed wireless network using a simple centralized algorithm to create a fair and efficient, high-performance bandwidth allocation schedule. Bandwidth allocation is typically based upon the requests of each individual link, all of the bandwidth requests in the network, link capacity, and inter-link interference. Thus, knowledge of the whole network, in terms of interference, eligible links, and link bandwidth requests is needed to create a bandwidth allocation schedule.

In the presently preferred embodiment of the invention, only one entity, referred to herein as a hub, needs this global view to compute the bandwidth allocation schedule. The bandwidth allocation schedule does not contain the actual slot assignment for each node. Rather, each node computes a slot assignment using a deterministic algorithm. Each grant in the bandwidth allocation schedule is a small integer. The bandwidth allocation schedule is not required to be sent periodically. The bandwidth allocation schedule is sent only when it changes. Hence, only a small amount of control traffic is used for dispatching the bandwidth allocation schedule.

Network Model

For purposes of the discussion herein, a network is defined as a set of links between nodes. For example, the unidirectional link between Node I and Node J is called Iᵢⱼ.

Suppose that there are N nodes and M directional links (Iᵢⱼ and Iⱼᵢ are considered different links) in a network. The interference between links in the network determines which links in the network can operate simultaneously. In other words, if a link Iᵢⱼ is active there exists a set of links Lᵢⱼ which cannot all be active at the same time. The set of all links Lᵢⱼ in the network constitute the interference matrix of the network.

For purposes of the discussion herein, the degree of interference α(Iᵢⱼ, L) of a directional link Iᵢⱼ in a set L of links is defined as the number of links in set L that cannot be active due to interference while link Iᵢⱼ is active.

The bandwidth needed by links to carry actual traffic over a specific time period is represented herein as a set of link bandwidth requests. The request may be zero. In that case, no traffic is to be carried over the link. Because link capacities vary depending on various link parameters, bandwidth requests are expressed in unit of credits, not bps (bits/sec). A credit is a unit the resource bandwidth allocation algorithm uses to maintain fair bandwidth distribution between links. It is the result of normalization of requested bandwidth, in terms of bps, with respect to the corresponding link capacity.

### EXAMPLE 1

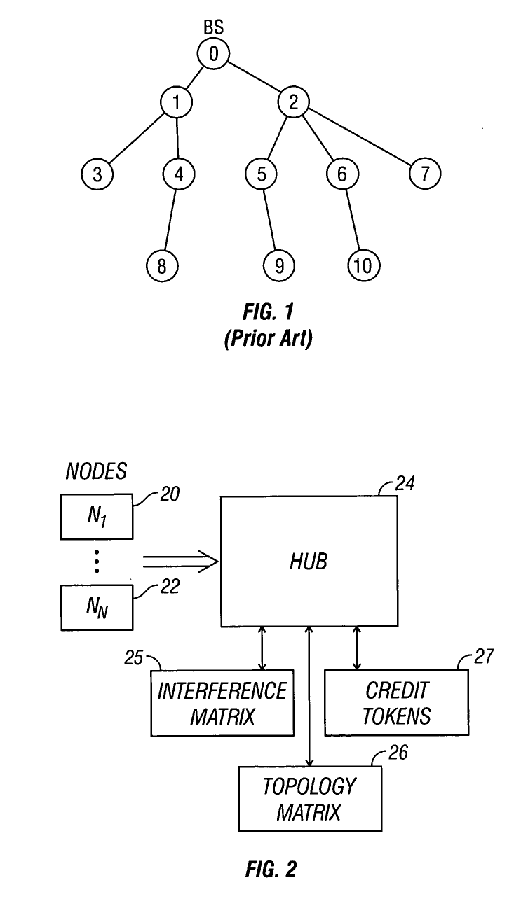

FIG. 1 is a tree diagram that shows a network having eleven nodes and twenty directional links:
{I_{0,1}, I_{1,0}, I_{0,2}, I_{2,0}, I_{1,3}, I_{3,1}, I_{1,4}, I_{4,1}, I_{2,5}, I_{5,2}, I_{2,6}, I_{6,2}, I_{2,7}, I_{7,2}, I_{4,8}, I_{8,4}, I_{5,9}, I₉₅, I_{6,10}, I_{10,6}}

Suppose that the set of links L_{0,1} that gets interference, i.e. that cannot be active while link I_{0,1} is active, is:
L_{0,1}={I_{1,0}, I_{0,2}, I_{2,0}, I_{1,3}, I_{3,1}, I_{1,4}, I_{4,1}, I_{5,9}, I_{8,4}}

Similarly, suppose there are the following interference sets:
L_{1,0}={I_{0,1}, I_{0,2}, I_{2,0}, I_{1,3}, I_{3,1}, I_{1,4}, I_{4,1}, I_{9,5}, I_{4,8}}
L_{0,2}={I_{1,0}, I_{0,1}, I_{2,0}, I_{2,5}, I_{5,2}, I_{2,6}, I_{6,2}, I_{2,7}, I_{7,2}I_{6,10}}
L_{2,10}={I_{1,0}, I_{0,1}, I_{0,2}, I_{2,5}, I_{5,2}, I_{2,6}, I_{6,2}, I_{2,7}, I_{7,2}, I_{10,6}}
L_{1,3}={I_{3,1}, I_{1,4}, I_{4,1}, I_{0,1}, I_{1,0}}
L_{3,1}={I_{1,3}, I_{1,4}, I_{4,1}, I_{0,1}, I_{1,0}}
L_{1,4}={I_{4,1}, I_{1,3}, I_{3,1}, I_{1,0}, I_{0,1}, I_{4,8}, I_{8,4}, I_{2,5}, I_{7,2}}
L_{4,1}={I_{1,4}, I_{1,3}, I_{3,1}, I_{1,0}, I_{0,1}, I_{4,8}, I_{8,4}, I_{5,2}, I_{2,7}}
L_{2,5}={I_{5,2}, I_{0,2}, I_{2,0}, I_{2,6}, I_{6,2}, I_{2,7}, I_{7,2}, I_{5,9}, I_{9,5}, I_{1,4}}
L_{5,2}={I_{2,5}, I_{0,2}, I_{2,0}, I_{2,6}, I_{6,2}, I_{2,7}, I_{7,2}, I_{5,9}, I_{9,5}I_{4,1}}
L_{2,6}={I_{6,2}, I_{0,2}, I_{2,0}, I_{2,5}, I_{5,2}, I_{2,7}, I_{7,2}, I_{6,10}, I_{10,6}}
L_{6,2}={I_{2,6}, I_{0,2}, I_{2,0}, I_{2,5}, I_{5,2}, I_{2,7}, I_{7,2}, I_{6,10}, I_{10,6}}
L_{2,7}={I_{7,2}, I_{0,2}, I_{2,0}, I_{2,5}, I_{5,2}, I_{2,6}, I_{6,2}, I_{4,1}}
L_{7,2}={I_{2,7}, I_{0,2}, I_{2,0}, I_{2,5}, I_{5,2}, I_{2,6}, I_{6,2}, I_{1,4}}
L_{4,8}={I_{8,4}, I_{1,4}, I_{4,1}, I_{1,0}}
L_{8,4}={I_{4,8}, I_{1,4}, I_{4,1}, I_{0,1}}
L_{5,9}={I_{9,5}, I_{2,5}, I_{5,2}, I_{0,1}}
L_{9,5}={I_{5,9}, I_{2,5}, I_{5,2}, I_{1,0}}
L_{6,10}={I_{10,6}, I_{2,6}, I_{6,2}, I_{0,2}}
L_{10,6}={I_{6,10}, I_{2,6}, I_{6,2}, I_{2,0}}

Equivalently, the interference can be expressed using the interference matrix I shown in Table 1 below.

TABLE 1
Interference Matrix I

| | I_{0,1} | I_{1,0} | I_{0,2} | I_{2,0} | I_{1,3} | I_{3,1} | I_{1,4} | I_{4,1} | I_{2,5} | I_{5,2} | I_{2,6} | I_{6,2} | I_{2,7} | I_{7,2} | I_{4,8} | I_{8,4} | I_{5,9} | I_{9,5} | I_{6,10} | I_{10,6} |
|---|---|---|---|---|---|---|---|---|---|---|---|---|---|---|---|---|---|---|---|---|
| I_{0,1} | | 1 | 1 | 1 | 1 | 1 | 1 | 1 | | | | | | | | 1 | 1 | | | |
| I_{1,0} | 1 | | 1 | 1 | 1 | 1 | 1 | 1 | | | | | | | 1 | | | 1 | | |
| I_{0,2} | 1 | 1 | | 1 | | | | | 1 | 1 | 1 | 1 | 1 | 1 | | | | | 1 | |
| I_{2,0} | 1 | 1 | 1 | | | | | | 1 | 1 | 1 | 1 | 1 | 1 | | | | | | 1 |
| I_{1,3} | 1 | 1 | | | | 1 | 1 | 1 | | | | | | | | | | | | |
| I_{3,1} | 1 | 1 | | | 1 | | 1 | 1 | | | | | | | | | | | | |
| I_{1,4} | 1 | 1 | | | 1 | 1 | | 1 | 1 | | | | | 1 | 1 | 1 | | | | |
| I_{4,1} | 1 | 1 | | | 1 | 1 | 1 | | | 1 | | | 1 | | 1 | 1 | | | | |
| I_{2,5} | | | 1 | 1 | | | 1 | | | 1 | 1 | 1 | 1 | 1 | | | 1 | 1 | | |
| I_{5,2} | | | 1 | 1 | | | | 1 | 1 | | 1 | 1 | 1 | 1 | | | 1 | 1 | | |
| I_{2,6} | | | 1 | 1 | | | | | 1 | 1 | | 1 | 1 | 1 | | | | | 1 | 1 |
| I_{6,2} | | | 1 | 1 | | | | | 1 | 1 | 1 | | 1 | 1 | | | | | 1 | 1 |
| I_{2,7} | | | 1 | 1 | | | | 1 | 1 | 1 | 1 | 1 | | 1 | | | | | | |
| I_{7,2} | | | 1 | 1 | | | 1 | | 1 | 1 | 1 | 1 | 1 | | | | | | | |
| I_{4,8} | | 1 | | | | | 1 | 1 | | | | | | | | 1 | | | | |
| I_{8,4} | 1 | | | | | | 1 | 1 | | | | | | | 1 | | | | | |
| I_{5,9} | 1 | | | | | | | | 1 | 1 | | | | | | | | 1 | | |
| I_{9,5} | | 1 | | | | | | | 1 | 1 | | | | | | | 1 | | | |
| I_{6,10} | | | 1 | | | | | | | | 1 | 1 | | | | | | | | 1 |
| I_{10,6} | | | | 1 | | | | | | | 1 | 1 | | | | | | | 1 | |

Number 1 in the matrix of Table 1 shows that links in a corresponding row and column cannot be active at the same time. Empty boxes in the matrix represent 0s.

A link bandwidth request is expressed in terms of the link capacity. Suppose that 64 credits are equivalent to full link capacity. If a link is given 64 credits, that link can be active all the time. If a link is given 32 credits, that link is active 50% of the time.

Suppose at a particular time, there exist the following bandwidth requests in credits:
R_{0,2}=35
R_{2,5}=20
R_{2,6}=15
R_{5,9}=10
R_{6,10}=10
R_{3,1}=10
R_{1,0}=10
R_{0,1}=5

The set of links requesting bandwidth is:
L={I_{0,2}, I_{2,5}, I_{2,6}, I_{5,9}, I_{6,10}, I_{3,1}, I_{1,0}, I_{0,1}}

Using the interference matrix I, the degree of interference of I_{0,2} in this set is computed as follows:
α(I_{0,2}, L)=I[I_{0,2}][I_{2,5}]+I[I_{0,2}][I_{2,6}]+I[I_{0,2}][I_{5,9}]+I[I_{0,2}][I_{6,10}]+I[I_{0,2}][I_{3,1}]+I[I_{0,2}][I_{1,0}]+I[I_{0,2}][I_{0,1}]=5

Other degrees of interference can be computed similarly:
α(I_{2,5}, L)=I[I_{2,5}][I_{0,2}]+I[I_{2,5}][I_{2,6}]+I[I_{2,5}][I_{5,9}]+I[I_{2,5}][I_{6,10}]+I[I_{2,5}][I_{3,1}]+I[I_{2,5}][I_{1,0}]+I[I_{2,5}][I_{0,1}]=3
α(I_{2,6}, L)=I[I_{2,6}][I_{0,2}]+I[I_{2,6}][I_{2,5}]+I[I_{2,6}][I_{5,9}]+I[I_{2,6}][I_{6,10}]+I[I_{2,6}][I_{3,1}]+I[I_{2,6}][I_{1,0}]+I[I_{2,6}][I_{0,1}]=3
α(I_{5,9}, L)=I[I_{5,9}][I_{0,2}]⇄I[I_{5,9}][I_{2,5}]+I[I_{5,9}][I_{2,6}]+I[I_{5,9}][I_{6,10}]+I[I_{5,9}][I_{3,1}]+I[I_{5,9}][I_{1,0}]+I[I_{5,9}][I_{0,1}]=2
α(I_{6,10}, L)=I[I_{6,10}][I_{0,2}]+I[I_{6,10}][I_{2,5}]+I[I_{6,10}][I_{2,6}]+I[I_{6,10}][I_{5,9}]+I[I_{6,10}][I_{3,1}]+I[I_{6,10}][I_{1,0}]+I[I_{6,10}][I_{0,1}]=2
α(I_{3,1}, L)=I[I_{3,1}][I_{0,2}]+I[I_{3,1}][I_{2,5}]+I[I_{3,1}][I_{2,6}]+I[I_{3,1}][I_{5,9}]+I[I_{3,1}][I_{6,10}]+I[I_{3,1}][I_{1,0}]+I[I_{3,1}][I_{0,1}]=1
α(I_{1,0}, L)=I[I_{1,0}][I_{0,2}]+I[I_{1,0}][I_{2,5}]+I[I_{1,0}][I_{2,6}]+I[I_{1,0}][I_{5,9}]+I[I_{1,0}][I_{6,10}]+I[I_{1,0}][I_{3,1}]+I[I_{1,0}][I_{0,1}]=3
α(I_{0,1}, L)=I[I_{0,1}][I_{0,2}]+I[I_{0,1}][I_{2,5}]+I[I_{0,1}][I_{2,6}]+I[I_{0,1}][I_{5,9}]+I[I_{0,1}][I_{6,10}]+I[I_{0,1}][I_{3,1}]+I[I_{0,1}][I_{1,0}]=4
Problem Formulation

Assume that time division multiple access (TDMA) techniques are used to multiplex link activities. Given the constraints of the interference matrix and a list of bandwidth requests, attempt to find a schedule to make optimal use of total network capacity and fairly satisfy bandwidth requests.

An equivalent problem is to find an optimal schedule that satisfies all requests using the least amount of network resources, in this case, credits or time. If the average activity concurrency is defined as the average number of concurrent active links of a schedule, then the optimal schedule is the one having the highest average activity concurrency.

A schedule specifies when a set of links are active and also specifies the members of the set. Mathematically, a schedule S can be expressed as:
S={(Lᵢ, G)|Gᵢ is the credits assigned to set of links Lᵢ,
Lᵢ is the set of links that can be all active at the same time without interfering with each other}

### EXAMPLE 2

Continuing with Example 1 above, the following is one possible schedule for links requesting bandwidth:
S={({I_{5,9}, I_{6,10}, I_{3,1}}, 10), ({I_{0,2}}, 35), ({I_{2,6}, I_{0,1}}5), ({I_{2,6}, I_{1,0}}10), ({I_{2,5}}, 20)}

This schedule uses 10+35+5+10+20=80 credits to satisfy 35+20+15+10+10+10+10+5=115 requested credits. The average activity concurrency is 115/80=1.4375.

This schedule is not necessarily the best schedule for this example. In fact, using the algorithm described in detail below, one can find a better schedule using less credits while still satisfying all bandwidth requests.

An optimal schedule must satisfy the following conditions:

For any link, granted credits equals requested credits
Σ_{Iijk⊂Li}Gᵢ=Rⱼₖ

Minimal total network resource spent
(ΣGᵢ)<=(ΣG′ᵢ) for ∀S′={(L′ᵢ, G′ᵢ)}

Because this problem is NP-hard, a heuristic algorithm is disclosed herein for a near optimal solution. For purposes of the discussion herein, a problem is NP-hard if an algorithm for solving it can be translated into one for solving any other NP-problem, i.e. nondeterministic polynomial time problem. NP-hard therefore means “at least as hard as any NP-problem,” although it might, in fact, be harder.

Simulations show that in many cases this algorithm generates optimal schedules; and in cases that it does not, the schedules are usually close to optimal and are always better than average.

Bandwidth Allocation Algorithm

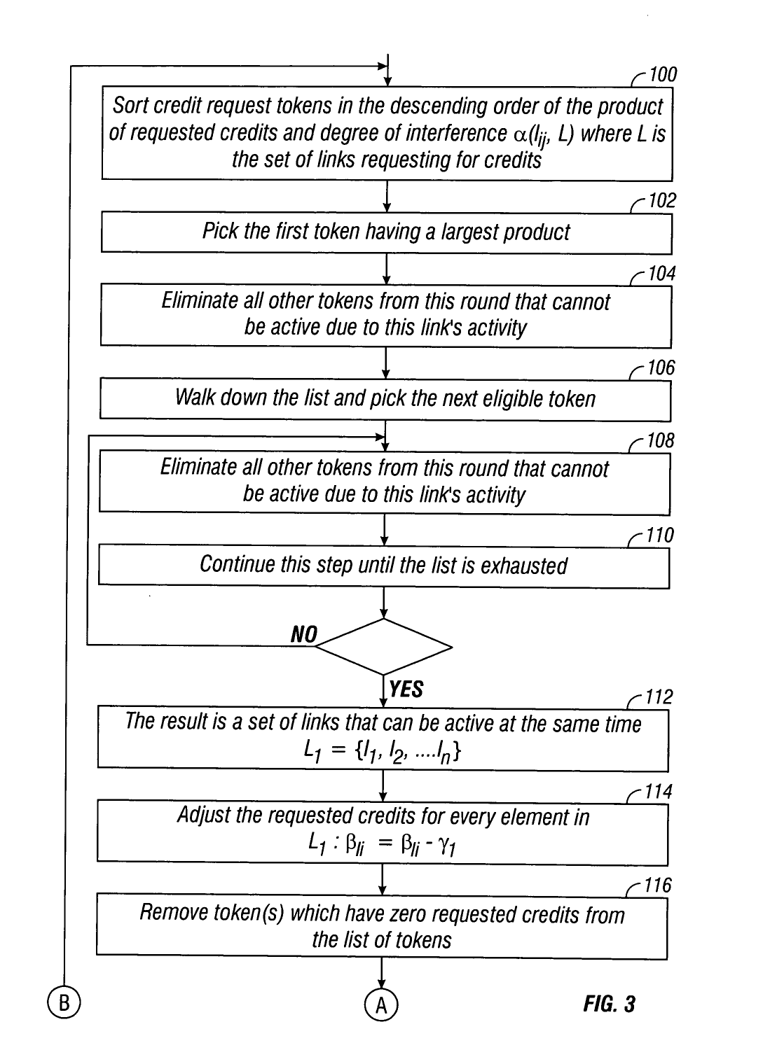

The algorithm disclosed herein is based on the assumption that there exists a centralized node (hub) in the network that coordinates all network activities (see FIG. 2). The hub 24 keeps the following data structures to represent its knowledge of the network:
Interference matrix 25 (defined above). It is important to note that interference matrix is symmetrical.
Topology matrix 26: defines valid links that can transmit/receive data. This is a proper subset of the interference matrix.
A list of credit request tokens 27. Each token represents a directional link that needs bandwidth.

Assume that each node 20, 22 in the network conveys its knowledge of interference, topology, and its bandwidth needs to the hub. The actual mechanism for transporting this information to the hub is within the knowledge of those skilled in the art and is, therefore, not discussed in detail herein. The hub collects this information from individual nodes and constructs the interference matrix, topology matrix, and list of credit tokens to have a complete view of the network.

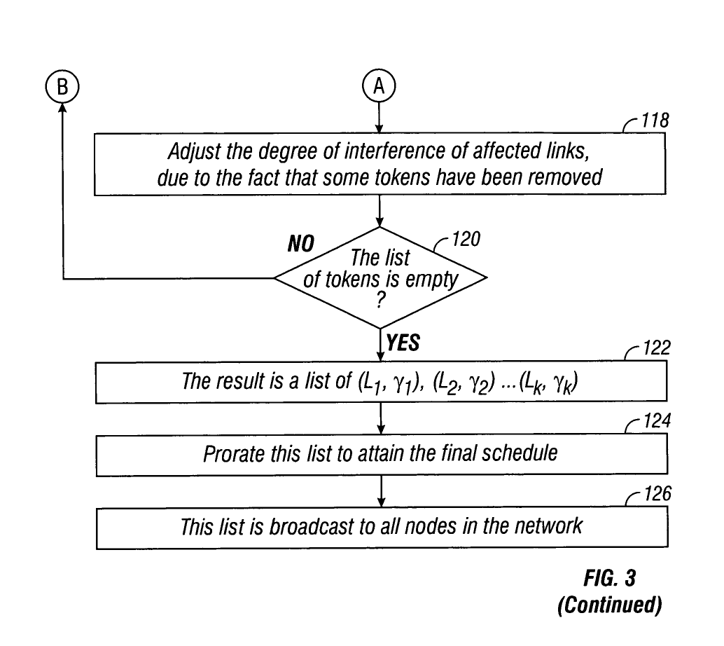

The bandwidth allocation algorithm running at hub is described as followed (see FIG. 3):
1. Sort credit request tokens in the descending order of the product of requested credits and degree of interference α(Iᵢⱼ, L), where L is the set of links requesting for credits (100).
2. Pick the first token having a largest product (102). This is the first candidate of the set of links to be allocated credit for this round. Eliminate all other tokens from this round that cannot be active due to this link's activity (104).
3. Walk down the list and pick the next eligible token (106). This is the second candidate of the set of links to be allocated credits for this round. Eliminate all other tokens from this round that cannot be active due to this link's activity (108). Continue this step until the list is exhausted (110).
4. The result is a set of links that can be active at the same time L₁={I₁, I₂, . . . , Iₙ} (112). Let β_{Ii} be requested credits of link Iᵢ. The amount of credits allocated to each element of set L₁ is γ₁=min{(β_{I1}, β_{I2}, . . . , β_{In}}. Adjust the requested credits for every element in L₁: β_{Ii}=β_{Ii}−γ₁ (114). Remove token(s) which have zero requested credits from the list of tokens (116).
5. Adjust the degree of interference of affected links, due to the fact that some tokens have been removed (118).
6. Repeat steps 1-5 until the list of tokens is empty (120).
7. The result is a list of (L₁, γ₁), (L₂, γ₂) . . . (Lₖ, γₖ) (122). Now, prorate this list to attain the final schedule (124). Let S be the total resource of the network in terms of credit; and let χᵢ=γᵢ*S//Σ^{0,k}γⱼ. The list (L₁, χ₁), (L₂, χ₂) . . . (Lₖ, χₖ) represents how the links are organized into sets of concurrent active links and how much resource each set of links are supposed to get. This list is broadcast to all nodes in the network (126).

### EXAMPLE 3

Use this algorithm to compute the schedule for Example 2.

Step 1 (see Table 2 below).

TABLE 2
Step 1

| | Degree of | | |
|---|---|---|---|
| Link | interference α(Iᵢⱼ, L) | Requested credit Rᵢⱼ | α(Iᵢⱼ, L) * Rᵢⱼ |
| I_{0,2} | 5 | 35 | 175 |
| I_{2,5} | 3 | 20 | 60 |
| I_{2,6} | 3 | 15 | 45 |
| I_{1,0} | 3 | 10 | 30 |
| I_{5,9} | 2 | 10 | 20 |
| I_{6,10} | 2 | 10 | 20 |
| I_{3,1} | 2 | 10 | 20 |
| I_{0,1} | 4 | 5 | 20 |

Steps 2-5:
Get the first Schedule S={({I_{0,2}, I_{5,9}, I_{3,1}},10)}

Go back to step 1 (see Table 3 below).

TABLE 3
Go Back to Step 1

| | Degree of | | |
|---|---|---|---|
| Link | interference α(Iᵢⱼ, L) | Requested credit Rᵢⱼ | α(Iᵢⱼ, L) * Rᵢⱼ |
| I_{0,2} | 5 | 25 | 125 |
| I_{2,5} | 2 | 20 | 40 |
| I_{2,6} | 2 | 15 | 30 |
| I_{1,0} | 2 | 10 | 20 |
| I_{6,10} | 2 | 10 | 20 |
| I_{0,1} | 2 | 5 | 10 |

Steps 2-5:
Get a revised Schedule S={({I_{0,2}, I_{5,9}, I_{3,1}}, 10), ({I_{0,2}}, 25)}

Go back to step 1 (see Table 4 below).

TABLE 4
Go Back to Step 1

| | Degree of | Requested | |
|---|---|---|---|
| Link | interference α(Iᵢⱼ, L) | credit Rᵢⱼ | α(Iᵢⱼ, L) * Rᵢⱼ |
| I_{2,5} | 1 | 20 | 20 |
| I_{2,6} | 1 | 15 | 15 |
| I_{1,0} | 1 | 10 | 10 |
| I_{6,10} | 1 | 10 | 10 |
| I_{0,1} | 1 | 5 | 5 |

Steps 2-5:

Get a revised Schedule:
S={({I_{0,2}, I_{5,9}, I_{3,1}}, 10), ({I_{0,2}}, 25), ({I_{2,5}, I_{1,0}, I_{6,0}}, 10)}.

Go back to step 1 (see Table 5 below).

TABLE 5
Go Back to Step 1

| | Degree of | | |
|---|---|---|---|
| Link | interference α(Iᵢⱼ, L) | Requested credit Rᵢⱼ | α(Iᵢⱼ, L) * Rᵢⱼ |
| I_{2,6} | 1 | 15 | 15 |
| I_{2,5} | 1 | 10 | 10 |
| I_{0,1} | 0 | 5 | 0 |

Steps 2-5:

Get a revised Schedule:
S={({I_{0,2}, I_{5,9}, I_{3,1}}, 10), ({I_{0,2}}, 25), ({I_{2,5}, I_{1,0}, I_{6,0}}, 10), ({I_{2,6}, I_{0,1}}, 5)}

Go back to step 1 (see Table 6 below)

TABLE 6
Go Back to Step 1

| | Degree of | | |
|---|---|---|---|
| Link | interference α(Iᵢⱼ, L) | Requested credit Rᵢⱼ | α(Iᵢⱼ, L) * Rᵢⱼ |
| I_{2,6} | 1 | 10 | 10 |
| I_{2,5} | 1 | 10 | 10 |

Steps 2-5:

Get a revised Schedule:
S={({I_{0,2}, I_{5,9}, I_{3,1}}, 10), ({I_{0,2}}, 25), ({I_{2,5}, I_{1,0}, I_{6,0}}, 10), ({I_{2,6}, I_{0,1}}5), ({I_{2,6}}, 10)}.

Go back to step 1 (see Table 7 below).

TABLE 7
Go Back to Step 1

| | Degree of | | |
|---|---|---|---|
| Link | interference α(Iᵢⱼ, L) | Requested credit Rᵢⱼ | α(Iᵢⱼ, L) * Rᵢⱼ |
| I_{2,5} | 1 | 10 | 10 |

Steps 2-5:

Get the schedule:
S={({I_{0,2}, I_{5,9}, I_{3,1}}, 10), ({I_{0,2}}, 25), ({I_{2,5}, I_{1,0}, I_{6,0}}, 10), ({I_{2,5}}, 10)}.

This schedule uses 10+25+10+5+10+10=70 credits to satisfy 35+20+15+10+10+10+10+5=115 requested credits. The average activity concurrency is 115/70=1.6428. Obviously, this schedule is better than the one presented in the previous example. In fact, it can be proved that this schedule is the optimal one for this particular example. There is no other schedule that can use less number of credits to satisfy all these bandwidth requests.

Step 7:

Because the total resource is only 64 credits, the previous schedule is prorated to obtain the final schedule:
S_{f}={({I_{0,2}, I_{5,9}, I_{3,1}}, 9), ({I_{0,2}}, 23), ({I_{2,5}, I_{1,0}, I_{6,0}}, 9), ({I_{2,6}, I_{0,1}}, 5), ({I_{2,6}}, 9), ({I_{2,5}}, 9)}.

This schedule is broadcast to all nodes in the network.

Upon receiving the schedule, each node in the network uses the binary allocation map scheme to compute its own slot assignment. Allocation map is an array of numbers that is used to map a range of consecutive numbers to partially equally spaced numbers. The idea is that, given a portion of resources, a node can figure out its active timeslots by projecting that portion (consecutive numbers) through the map. For example, all links in set Lᵢ are assigned to the range [Σ^{0,i-1} χⱼ, Σ^{0,i} χⱼ], which, in turn, represent a set of near-equally spaced time slots.

### EXAMPLE 4

Assume that the allocation map is designed for 64 time slots, corresponding to 64 credits.

The allocation map for 64 time slots is shown in Table 8 below.

TABLE 8
Allocation Map, 64 Time Slots

| | tslot | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| index | 1 | 33 | 17 | 49 | 9 | 41 | 25 | 57 | 5 | 37 | 21 | 53 | 13 | 45 | 29 | 61 |
| | tslot | | | | | | | | | | | | | | | |
| | 17 | 18 | 19 | 20 | 21 | 22 | 23 | 24 | 25 | 26 | 27 | 28 | 29 | 30 | 31 | 32 |
| index | 3 | 35 | 19 | 51 | 11 | 43 | 27 | 59 | 7 | 39 | 23 | 55 | 15 | 47 | 31 | 63 |
| | tslot | | | | | | | | | | | | | | | |
| | 33 | 34 | 35 | 36 | 37 | 38 | 39 | 40 | 41 | 42 | 43 | 44 | 45 | 46 | 47 | 48 |
| index | 2 | 34 | 18 | 50 | 10 | 42 | 26 | 58 | 6 | 38 | 22 | 54 | 14 | 46 | 30 | 62 |
| | tslot | | | | | | | | | | | | | | | |
| | 49 | 50 | 51 | 52 | 53 | 54 | 55 | 56 | 57 | 58 | 59 | 60 | 61 | 62 | 63 | 64 |
| index | 4 | 36 | 20 | 52 | 12 | 44 | 28 | 60 | 8 | 40 | 24 | 56 | 16 | 48 | 32 | 64 |

A range of credit indices can be deduced for each set of links in the final schedule S_{f}. For example, the set {I_{0,2}, I_{5,9}, I_{3,1}} is correspondent to [1,9]. Set {I_{0,2}} is correspondent to [10,32]; and soon.
S_{f}={({I_{0,2}, I_{5,9}, I_{3,1}}, 9), ({I_{0,2}}, 23), ({I_{2,5}, I_{1,0}, I_{6,0}}, 9), ({I_{2,6}, I_{0,1}}, 5), ({I_{2,6}}9), ({I_{2,5}}, 9)}

Using the combination of allocation map and the final schedule S_{f}, any node is aware of which link is active at a particular time slot t. For example, the set {I_{0,2}, I_{5,9}, I_{3,1}} is active in time slots 1, 5, 9, 17, 25, 33, 41, 49, 57.

Maximizing Network Capacity Using Unscheduled Time Slots

To facilitate the explanation of using unscheduled time slots, use the schedule obtained in previous example.
S={({I_{0,2}, I_{5,9}, I_{3,1}}, 10), ({I_{0,2}}, 25), ({I_{2,5}, I_{1,0}, I_{6,0}}, 10), ({I_{2,6}, I_{0,1}}, 5), ({I_{2,6}}, 10), ({I_{2,5}}10)}

Some notable points need to be made about this schedule:
1. The number of links in each set tends to be highest at the beginning of the schedule and tends to taper off toward the end of the schedule.
2. Even with the set causing most interference in the network, there are some links that can be active at the same time without causing interference to the links in the set.
3. The interference caused by sets at the beginning of the schedule tend to be the highest; and that interference tends to taper off going toward the end of the schedule.

With these observations, it can be seen the scheduled bandwidth very likely represents only about half of total network capacity. Hence, a collision-based mechanism is devised to use the other half, which is going to be wasted if not used otherwise.

Each node in the network maintains, for each of its local links, one set of links interfering with that link. Local links are links directly connected to the node. By using the schedule S broadcast by the Hub, a node knows which of its local links can be active without interfering with the scheduled links which are currently active. An active unscheduled link at time slot t is a link that is not scheduled to be active at time t, but could be made active if the intended receiver is ready to receive. This can be decided by its directly connected nodes because this activity does not cause interference with the current active scheduled links. A link can be unscheduled at one time slot and is scheduled in another time slot. Active unscheduled links can interfere and collide which each other, but they do not interfere with the currently active scheduled links.

Unscheduled links are mainly used when a node does not have uplink scheduled bandwidth and need to request bandwidth or need to send some small uplink transient traffic. It is used to boost up network capacity, as well as network response time.

### EXAMPLE 5

Using Example 4, the final schedule is:
S={({I_{0,2}, I_{5,9}, I_{3,1}}, 10), ({I_{0,2}}, 25), ({I_{2,5}, I_{1,0}, I_{6,0}}, 10), ({I_{2,6}, I_{0,1}}, 5), ({I_{2,6}}, 10), ({I_{2,5}}10)}

Pick one time slot t. Suppose that it corresponds to ({I_{2,6}, I_{0,1}}, 5) in the schedule. This means that I_{2,6} and I_{0,1} are active at time slot t. The matrix of interference indicates that any of links {I_{4,8} I_{9,5}} can also be active. Although each node does not maintain the matrix of interference for the whole network, it does keep sets of interference links for each of its local link. Hence, local nodes (4 and 9) know that they can activate the link at time slot t. In this specific example, if both I_{4,8} I_{9,5} are active, they still do not collide. However, that is not always the case. Nodes can use a backoff mechanism to resolve collision if it happens.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for bandwidth allocation for a wireless network, comprising the steps of:
using a matrix of interlink interference and a list of links' bandwidth requests to schedule link activities to obtain non-collision transmissions;
wherein bandwidth needed by said links to carry actual traffic over a specific time period is represented as a set of link bandwidth requests;
wherein bandwidth requests are expressed in units of credits; and
wherein a credit is a unit assigned to said bandwidth requests to maintain fair bandwidth distribution between said links; and
prorating bandwidth granted for each link based on said link's requested bandwidth, total requested bandwidth in said wireless network, and network capacity.

2. The method of claim 1, further comprising the steps of:
providing a centralized node in said wireless network for coordinating substantially all network activities.

3. The method of claim 2, wherein said hub comprises:
an interference matrix;
a topology matrix for defining valid links that can transmit/receive data; and
a list of credit request tokens, wherein each token represents a directional link that needs bandwidth.

4. The method of claim 3, said hub collecting information from individual nodes and constructing said interference matrix, topology matrix, and list of credit tokens therefrom.

5. A bandwidth allocation method for a network, comprising the steps of:
sorting credit request tokens in descending order of a product of requested credits and degree of interference α(Iᵢⱼ, L), where L is a set of links requesting credits;
picking a first token having a largest product, wherein said first token is a first candidate link of a set of links to be allocated credit for a first round;
eliminating all other tokens from said first round that cannot be active due to said first candidate link's activity;
walking down a list and picking a next eligible token, wherein said next eligible token comprises a second candidate link of said set of links to be allocated credits for a second round;
eliminating all other tokens from said second round that cannot be active due to said second candidate link's activity; and
continuing until said list of links is exhausted;
producing a set of links that can be active at a same time L₁={I₁, I₂, . . . , Iₙ}.

6. The method of claim 5, further comprising the steps of:
letting β_{Ii} be requested credits of link Iⱼ, wherein an amount of credits allocated to each element of set L₁ is γ₁=min{β_{I1}, β_{I2}, . . . , β_{In}};
adjusting said requested credits for every element in L₁: β_{Ii}=β_{Ii}−γ₁; and
removing tokens which have zero requested credits from said list of tokens.

7. The method of claim 6, further comprising the step of:
adjusting a degree of interference of affected links, due to the fact that some tokens have been removed.

8. The method of claim 7, further comprising the step of:
repeating all foregoing steps until said list of tokens is empty.

9. The method of claim 8, wherein a list (L₁, γ₁), (L₂, γ₂) . . . (Lₖ, γₖ) results.

10. The method of claim 9, further comprising the steps of:
prorate said list to attain a final schedule;
letting S be a total resource of a network in terms of credit; and
letting χᵢ=γᵢ*S//Σ_{0,k}γⱼ;
wherein said list (L₁, χ₁), (L₂, χ₂) . . . (Lₖ, γₖ) represents how said links are organized into sets of concurrent active links and how much resource each set of links is supposed to get.

11. The method of claim 10, further comprising the step of:
broadcasting said list (L₁, χ₁), (L₂, χ₂) . . . (Lₖ, χₖ) to all nodes in said network.

12. An apparatus for bandwidth allocation for a wireless network, comprising:
a matrix of interlink interference;
a list of links' bandwidth requests;
wherein said matrix of interlink interference and said list of links' bandwidth requests is used to schedule link activities to obtain non-collision transmissions;
wherein bandwidth needed by said links to carry actual traffic over a specific time period is represented as a set of link bandwidth requests;
wherein bandwidth requests are expressed in units of credits; and
wherein a credit is a unit assigned to said bandwidth requests to maintain fair bandwidth distribution between said links; and
means for prorating bandwidth granted for each link based on said link's requested bandwidth, total requested bandwidth in said wireless network, and network capacity.

13. The apparatus of claim 12, further comprising:
a centralized node in said wireless network for coordinating substantially all network activities.

14. The apparatus of claim 12, wherein said hub comprises:
an interference matrix;
a topology matrix for defining valid links that can transmit/receive data; and
a list of credit request tokens, wherein each token represents a directional link that needs bandwidth.

15. The apparatus of claim 13, further comprising:
means for said hub collecting information from individual nodes and constructing said interference matrix, topology matrix, and list of credit tokens therefrom.
